(19) United States
(12) Patent Application Publication
(10) Pub. No.: US 2011/0134178 A1
(43) Pub. Date: Jun. 9, 2011

(54) PRINTING APPARATUS AND PRINTING CONTROL METHOD

(76) Inventor: Yuhei CHIWATA, Kanagawa-ken (JP)

(21) Appl. No.: 12/962,688

(22) Filed: Dec. 8, 2010

(30) Foreign Application Priority Data
Dec. 9, 2009 (JP) 2009-279615

(51) Int. Cl. B41J 29/38

(52) U.S. Cl. 347/14

(57) ABSTRACT

The printing apparatus includes: an image formation device which performs front-side printing to form a front-side image on a front side of paper according to front-side image data, and then performs rear-side printing to form a rear-side image on a rear side of the paper according to rear-side image data; a device which predicts an amount of size variation occurring in the paper during a period from a time of depositing ink in the front-side printing to a time of starting the rear-side printing; a device which calculates a correction amount for correcting a difference between actual sizes of the front-side and rear-side images at a time of depositing ink in the rear-side printing, according to the predicted amount of size variation; and a device which corrects the front-side image data and/or the rear-side image data to be supplied to the image formation device, according to the calculated correction amount.

### BACKGROUND OF THE INVENTION

1. Field of the Invention

The present invention relates to a printing apparatus and a printing control method whereby it is possible to improve the dimensional accuracy of images on front and rear sides in double-side printing.

2. Description of the Related Art

There is known a printing apparatus which forms an image on paper by depositing ink onto the paper. In inkjet recording using aqueous ink in particular, deformation of the paper (expansion of the image formation portion) occurs inevitably with the permeation of the ink into the paper. In a so-called shuttle scanning inkjet recording method in which an inkjet head is moved reciprocally in a direction perpendicular to the paper conveyance direction, the page printing time is long and the printing process and deformation of the paper occur simultaneously and progressively, and hence printing accuracy in terms of color registration of the printed image, front/rear side registration when carrying out double-side printing, and the dimensions of figures (dimensional reproducibility of input image data), and the like, has not by any means been desirable. Moreover, problems such as curling and cockling (undulation) of the paper also occur, and there have also been problems with print quality and compatibility with double-side printing.

Japanese Patent Application Publication No. 2002-333744 discloses technology for measuring the amount of expansion and contraction of the paper before and after heating and fixing, setting beforehand correction values for image data, and correcting the image data in printing. Japanese Patent Application Publication No. 2001-282042 discloses technology in which the magnification rate of an image is corrected by taking as a parameter the number of times heating and fixing is carried out after the image formation. Japanese Patent Application Publication No. 2001-287428 discloses technology for altering the control parameters (paper conveyance timing, speed of rotation, and the like) of a paper conveyance roller during rear-side printing in accordance with the image printing contents on a front side in order to eliminate paper positioning errors during the rear-side printing as a result of curling and cockling after the front-side printing.

Furthermore, in recent years, due to the requirement for high-speed printing, there has been ongoing investigation into single pass inkjet recording methods using long fixed heads having the length corresponding to the width of the paper.

Japanese Patent Application Publication Nos. 2007-175922 and 2007-175923 disclose technology for achieving double-side printing compatibility by reducing cockling and curling of paper by holding the paper on a conveyance table by vacuum suction or electrostatic attraction when carrying out recording by a single pass method using a long head. Japanese Patent Application Publication No. 2007-160839 discloses technology for reducing curl and cockling by forced drying of a side of paper within 0 to 3 seconds after image formation, when carrying out recording by a single-pass method.

It is difficult to completely suppress paper deformation, even if using the paper holding technology (Japanese Patent Application Publication Nos. 2007-175922 and 2007-175923) or the forced drying technology (Japanese Patent Application Publication No. 2007-160839) described above; however, it is possible to carry out image formation before paper deformation occurs when performing single-side printing, because the ink deposition time (image formation time) on the paper can be made short (for example, approximately 0.5 seconds to 3 seconds per page) in the case of the single pass method which is capable of forming an image simply by moving the paper relatively with respect to an inkjet head just once, in a single direction. In other words, it is possible to achieve high accuracy of the color registration and of the dimensions of figures within one side of the paper.

However, in double-side printing, expansion and/or contraction (hereinafter referred to as “size variation”) of the paper due to the image formation onto the front side has already occurred by the start of image formation on the rear side, and hence there has been a problem in that image dimension errors occur between the front side and the rear side. In particular, when forming images having the same vertical and horizontal sizes onto the front and rear sides of the paper, image dimension errors between the front and rear sides are especially noticeable.

Furthermore, the amount of size variation occurring in the paper during a period from the deposition of ink on the front side to the deposition of ink on the rear side is greatly dependent on the input image data for the front-side printing. Hence, even if the image data for the rear side is corrected using previously established image correction parameters, improvement in the dimensional accuracy of the image on the rear side cannot be expected.

### SUMMARY OF THE INVENTION

The present invention has been contrived in view of these circumstances, an object thereof being to provide a printing apparatus and a printing control method whereby the dimensional accuracy of images on front and rear sides of paper in the case of double-side printing can be improved reliably.

In order to attain the aforementioned object, the present invention is directed to a printing apparatus, comprising: an image formation device which performs front-side printing to form a front-side image on a front side of paper by depositing ink in a single pass onto the front side of the paper in accordance with front-side image data, and then performs rear-side printing to form a rear-side image on a rear side of the paper by depositing ink in a single pass onto the rear side of the paper in accordance with rear-side image data; a paper size variation amount prediction device which predicts an amount of size variation occurring in the paper during a period from a time of depositing the ink in the front-side printing to a time of starting the rear-side printing, in accordance with at least the front-side image data; an image correction amount calculation device which calculates an image correction amount for correcting a difference between an actual size of the front-side image and an actual size of the rear-side image on the paper at a time of depositing the ink in the rear-side printing, in accordance with the predicted amount of size variation; and an image data correction device which corrects at least one of the front-side image data and the rear-side image data to be supplied to the image formation device, in accordance with the calculated image correction amount.

According to this aspect of the present invention, the amount of size variation occurring in the paper during the period from the ink deposition in the front-side printing to the start of the rear-side printing is predicted on the basis of at least the front-side image data, the image correction amount for correcting the difference between the actual size of the front image and the actual size of the rear-side image on the paper at the time of the ink deposition in the rear-side printing is calculated on the basis of the predicted amount of size variation, the image data is corrected on the basis of the calculated image correction amount, and the ink is deposited in the single pass onto the paper on the basis of the corrected image data, and therefore it is possible reliably to improve the dimensional accuracy of the images formed on the front and rear sides of paper in the double-side printing, in accordance with the input image data. In particular, if the original sizes of the input front-side image data and the input rear-side image data are the same, then it is possible to match the actual size of the front-side image on the paper and the actual size of the rear-side image on the paper at the time of the ink deposition in the rear-side printing.

In order to attain the aforementioned object, the present invention is also directed to a printing apparatus, comprising: an image formation device which performs front-side printing to form a front-side image on a front side of paper by depositing ink in a single pass onto the front side of the paper in accordance with front-side image data, and then performs rear-side printing to form a rear-side image on a rear side of the paper by depositing ink in a single pass onto the rear side of the paper in accordance with rear-side image data; a pre-coating device which deposits a pre-coating liquid onto each of the front side and the rear side of the paper before the ink is deposited; a paper size variation amount prediction device which predicts a first amount of size variation occurring in the paper during a period from a time of depositing the ink in the front-side printing to a time of starting to deposit the pre-coating liquid onto the rear side of the paper, and predicts a second amount of size variation occurring in the paper during a period from a time of depositing the pre-coating liquid onto the rear side of the paper to a time of starting to deposit the ink onto the rear side of the paper, in accordance with at least a volume of the pre-coating liquid deposited onto the rear side of the paper; an image correction amount calculation device which calculates an image correction amount for correcting a difference between an actual size of the front-side image and an actual size of the rear-side image on the paper at a time of depositing the ink in the rear-side printing, in accordance with the predicted first and second amounts of size variation; and an image data correction device which corrects at least one of the front-side image data and the rear-side image data to be supplied to the image formation device, in accordance with the calculated image correction amount.

According to this aspect of the present invention, it is possible to improve the image quality by carrying out the pre-coating, as well as reliably improving the dimensional accuracy of the images on the front and rear sides of the paper in the double-side printing.

Preferably, the image data correction device corrects both the front-side image data and the rear-side image data.

It is also preferable that the image data correction device corrects only the front-side image data. According to this aspect of the present invention, the size correction for one side only is sufficient, and therefore the image correction processing time is reduced.

It is also preferable that the image data correction device corrects only the rear-side image data. According to this aspect of the present invention, the size correction for one side only is sufficient, and therefore the image correction processing time is reduced.

Preferably, the paper size variation amount prediction device predicts the first amount of size variation in accordance with at least a volume of the ink on the front side of the paper.

It is also preferable that the paper size variation amount prediction device predicts the amount of size variation in accordance with at least an average volume of the ink on the front side of the paper. According to this aspect of the present invention, it is possible to easily calculate the amount of size variation in the paper, by calculating the average ink volume.

It is also preferable that the paper size variation amount prediction device predicts the amount of size variation in accordance with at least a volume distribution of the ink on the front side of the paper. According to this aspect of the present invention, it is possible to accurately calculate the amount of size variation in the paper, even in cases where non-uniform size variation occurs dependently on the image pattern within the sheet of the paper.

It is also preferable that the paper size variation amount prediction device predicts the amount of size variation in accordance with at least a printing mode of the front side of the paper. According to this aspect of the present invention, it is possible to readily calculate the amount of size variation in the paper.

Preferably, the printing apparatus further comprises: a seasoning device which performs seasoning of the paper by blowing air to the paper, wherein the paper size variation amount prediction device predicts the amount of size variation while taking account of a seasoning condition of the front side of the paper in the seasoning device.

Preferably, the paper size variation amount prediction device further predicts an amount of size variation occurring in the paper during a period from the time of depositing the ink in the rear-side printing to a time of completing the rear-side printing; and the image data correction device corrects the actual size of the front-side image and the actual size of the rear-side image on the paper at completion of double-side printing by correcting the at least one of the front-side image data and the rear-side image data while taking account of the further predicted amount of size variation.

In order to attain the aforementioned object, the present invention is also directed to a printing control method of carrying out double-side printing using an image formation device which performs front-side printing to form a front-side image on a front side of paper by depositing ink in a single pass onto the front side of the paper in accordance with front-side image data, and then performs rear-side printing to form a rear-side image on a rear side of the paper by depositing ink in a single pass onto the rear side of the paper in accordance with rear-side image data, the method comprising: a paper size variation amount prediction step of predicting an amount of size variation occurring in the paper during a period from a time of depositing the ink in the front-side printing to a time of starting the rear-side printing, in accordance with at least the front-side image data; an image correction amount calculation step of calculating an image correction amount for correcting a difference between an actual size of the front-side image and an actual size of the rear-side image on the paper at a time of depositing the ink in the rear-side printing, in accordance with the predicted amount of size variation; and an image data correction step of correcting at least one of the front-side image data and the rear-side image data to be supplied to the image formation device, in accordance with the calculated image correction amount.

In order to attain the aforementioned object, the present invention is also directed to a printing control method of carrying out double-side printing using an image formation device which performs front-side printing to form a front-side image on a front side of paper by depositing ink in a single pass onto the front side of the paper in accordance with front-side image data, and then performs rear-side printing to form a rear-side image on a rear side of the paper by depositing ink in a single pass onto the rear side of the paper in accordance with rear-side image data, and a pre-coating device which deposits a pre-coating liquid onto each of the front side and the rear side of the paper before the ink is deposited, the method comprising: a paper size variation amount prediction step of predicting a first amount of size variation occurring in the paper during a period from a time of depositing the ink in the front-side printing to a time of starting to deposit the pre-coating liquid onto the rear side of the paper, and predicting a second amount of size variation occurring in the paper during a period from a time of depositing the pre-coating liquid onto the rear side of the paper to a time of starting to deposit the ink onto the rear side of the paper, in accordance with at least a volume of the pre-coating liquid deposited onto the rear side of the paper; an image correction amount calculation step of calculating an image correction amount for correcting a difference between an actual size of the front-side image and an actual size of the rear-side image on the paper at a time of depositing the ink in the rear-side printing, in accordance with the predicted first and second amounts of size variation; and an image data correction step of correcting at least one of the front-side image data and the rear-side image data to be supplied to the image formation device, in accordance with the calculated image correction amount.

According to the present invention, it is possible reliably to improve the dimensional accuracy of the images on the front and rear sides of the paper in the double-side printing, in accordance with the input image data.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a general schematic drawing of an inkjet printing apparatus as an embodiment of a printing apparatus according to the present invention;

FIG. 2 is an illustrative diagram for describing the relationship between respective processes in double-side printing in the inkjet printing apparatus in FIG. 1 and the amounts of size variation occurring in the paper;

FIG. 3 is a principal block diagram of a control system in a first embodiment;

FIG. 4 is a principal block diagram of a control system in a second embodiment;

FIG. 5 is a principal block diagram of a control system in a third embodiment;

FIG. 6 is a principal block diagram of a control system in a fourth embodiment;

FIG. 7 is a flowchart showing an overview of a sequence of an embodiment of a double-side printing process;

FIG. 8 is an illustrative diagram for describing an example of predicting an amount of size variation occurring in the paper;

FIG. 9 is a general schematic drawing of an inkjet printing apparatus as another embodiment of a printing apparatus according to the present invention;

FIG. 10 is an illustrative diagram for describing the relationship between respective processes in double-side printing in the inkjet printing apparatus in FIG. 9 and the amounts of size variation occurring in the paper;

FIG. 11 is a principal block diagram of a control system in a fifth embodiment;

FIG. 12 is a principal block diagram of a control system in a sixth embodiment;

FIG. 13 is a principal block diagram of a control system in a seventh embodiment;

FIG. 14 is a perspective diagram showing an embodiment of a seasoning mechanism; and

FIG. 15 is a perspective diagram showing an embodiment of an air blowing device in the seasoning mechanism in FIG. 14.

### DETAILED DESCRIPTION OF THE PREFERRED EMBODIMENTS

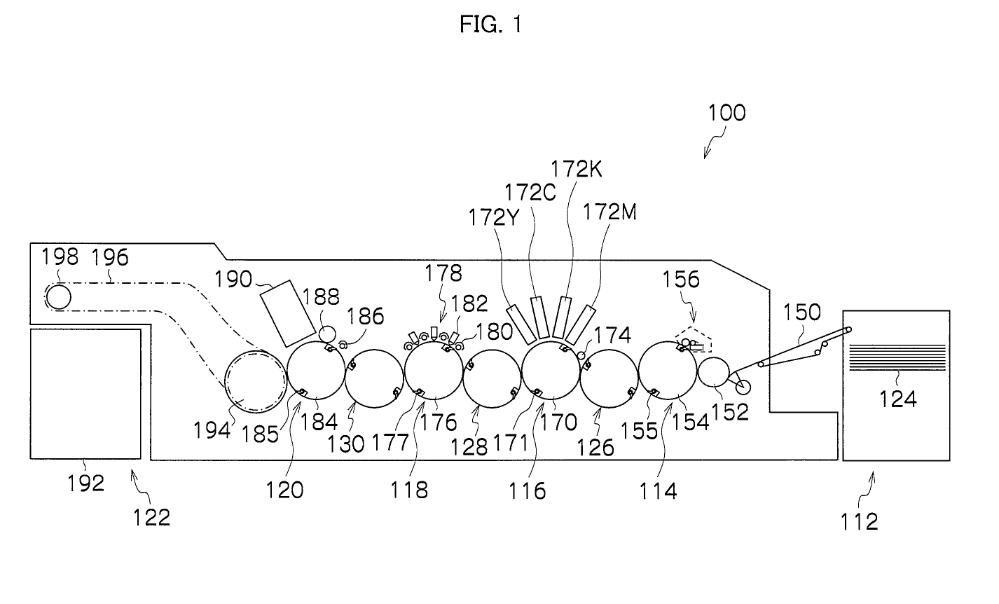

FIG. 1 is a structural diagram illustrating the configuration of an inkjet printing apparatus 100 according to an embodiment of the present invention. The inkjet printing apparatus 100 is of a so-called pressure-drum direct image-formation system which records a desired color image on a recording medium (hereinafter also referred to as “paper”) 124 held on a pressure drum (an image formation drum 170) of an image formation unit 116 by ejecting and depositing droplets of ink of a plurality of colors from inkjet heads 172M, 172K, 172C and 172Y onto the recording medium 124. More specifically, the inkjet printing apparatus 100 is of an on-demand type which adapts a two-liquids reaction (aggregation in the present embodiment) system in which treatment liquid (aggregation treatment liquid in the present embodiment) is deposited onto the recording medium 124 prior to the deposition of the ink, so that the deposited ink reacts with the treatment liquid to form images on the recording medium 124.

The inkjet printing apparatus 100 includes a paper feed unit 112, a treatment liquid deposition unit 114, the image formation unit 116, a drying unit 118, a fixing unit 120, and a paper output section 122 as the main components.

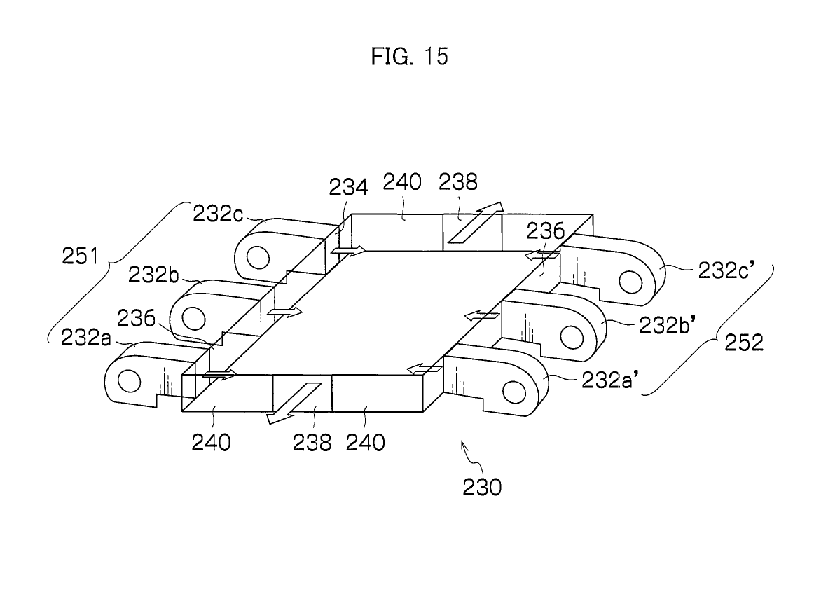

The paper output section 122 has an output unit 192 provided with an air blowing device 230 (see FIG. 15) described later, which passes air to season a stack of sheets of paper which have been output.

The paper feed unit 112 feeds the recording medium 124 to the treatment liquid deposition unit 114. The recording media (paper sheets) 124 are stacked in the paper feed unit 112. The paper feed unit 112 is provided with a paper feed tray 150, and the recording media 124 are fed, sheet by sheet, from the paper feed tray 150 to the treatment liquid deposition unit 114.

In the inkjet printing apparatus 100 according to the present embodiment, it is possible to use recording media of different types and various sizes as the recording media 124. A mode can be adopted in which the paper feed unit 112 is provided with a plurality of paper trays (not illustrated) in which recording media of different types are respectively sorted and stacked, and the paper that is fed to the paper feed tray 150 from the paper trays is automatically switched, and a mode can also be adopted in which an operator selects or exchanges the paper tray in accordance with requirements. In the present embodiment, cut sheets of paper are used as the recording media 124, but it is also possible to cut paper to a required size from a continuous roll of paper and then supply this cut sheet of the paper.

The treatment liquid deposition unit 114 is a mechanism that deposits the treatment liquid onto the recording surface of the recording medium 124. The treatment liquid includes a coloring material aggregating agent that causes the aggregation of a coloring material (pigment in the present embodiment) contained in the ink to be deposited in the image formation unit 116, and the separation of the coloring material and a solvent in the ink is enhanced when the treatment liquid is brought into contact with the ink.

As shown in FIG. 1, the treatment liquid deposition unit 114 includes a paper transfer drum 152, a treatment liquid drum 154, and a treatment liquid application device 156. The treatment liquid drum 154 is a drum that holds and rotationally conveys the recording medium 124. The treatment liquid drum 154 is provided on the outer circumferential surface thereof with a hook-shaped holding device (gripper) 155, which holds the leading end of the recording medium 124 by gripping the recording medium 124 between the hook of the gripper 155 and the circumferential surface of the treatment liquid drum 154. The treatment liquid drum 154 can be provided with suction apertures on the outer circumferential surface thereof and connected to a suction device that performs suction through the suction apertures. As a result, the recording medium 124 can be tightly held on the outer circumferential surface of the treatment liquid drum 154.

The treatment liquid application device 156 is disposed on the outside of the treatment liquid drum 154 opposite the outer circumferential surface thereof. The treatment liquid application device 156 includes: a treatment liquid container, in which the treatment liquid to be applied is held; an anilox roller, a part of which is immersed in the treatment liquid held in the treatment liquid container; and a rubber roller, which is pressed against the anilox roller and the recording medium 124 that is held by the treatment liquid drum 154, so as to transfer the treatment liquid metered by the anilox roller to the recording medium 124. The treatment liquid application device 156 can apply the treatment liquid onto the recording medium 124 while metering.

In the present embodiment, the application system using the roller is employed; however, the present invention is not limited to this, and it is possible to employ a spraying method, an inkjet method, or other methods of various types.

The recording medium 124 on which the treatment liquid has been deposited in the treatment liquid deposition unit 114 is transferred from the treatment liquid drum 154 through the intermediate conveyance unit 126 to the image formation drum 170 of the image formation unit 116.

The image formation unit 116 includes the image formation drum 170, a paper pressing roller 174 and the inkjet heads 172M, 172K, 172C and 172Y. Similar to the treatment liquid drum 154, the image formation drum 170 is provided on the outer circumferential surface thereof with a hook-shaped holding device (gripper) 171. The recording medium 124 held on the image formation drum 170 is conveyed in a state where the recording surface thereof faces outward, and inks are deposited onto the recording surface by the inkjet heads 172M, 172K, 172C and 172Y.

The inkjet heads 172M, 172K, 172C and 172Y are recording heads (inkjet heads) of the inkjet system of the full line type that have a length corresponding to the maximum width of the image formation region in the recording medium 124. A nozzle row is formed on the ink ejection surface of the inkjet head. The nozzle row has a plurality of nozzles arranged therein for discharging ink over the entire width of the image recording region. Each of the inkjet heads 172M, 172K, 172C and 172Y is fixedly disposed so as to extend in the direction perpendicular to the conveyance direction (rotation direction of the image formation drum 170) of the recording medium 124.

Droplets of corresponding colored inks are ejected from the inkjet heads 172M, 172K, 172C and 172Y toward the recording surface of the recording medium 124 held tightly on the image formation drum 170, and thereby the ink comes into contact with the treatment liquid that has been heretofore deposited on the recording surface by the treatment liquid deposition unit 114, the coloring material (pigment) dispersed in the ink is aggregated, and a coloring material aggregate is formed. Thus, the coloring material flow on the recording medium 124 is prevented, and an image is formed on the recording surface of the recording medium 124.

In the present embodiment, the CMYK standard color (four colors) configuration is described, but combinations of ink colors and numbers of colors are not limited to that of the present embodiment, and if necessary, light inks, dark inks, and special color inks may be added. For example, a configuration is possible in which inkjet heads are added that eject light inks such as light cyan and light magenta. The arrangement order of color heads is also not limited.

It is possible to carry out image formation onto the recording medium 124 in a single pass by means of the image formation unit 116 composed as described above.

The recording medium 124 on which the image has been formed in the image formation unit 116 is transferred from the image formation drum 170 through an intermediate conveyance unit 128 to a drying drum 176 of the drying unit 118.

The drying unit 118 dries water included in the solvent separated by the coloring material aggregation action. As shown in FIG. 1, the drying unit includes the drying drum 176 and a solvent dryer 178.

Similar to the treatment liquid drum 154, the drying drum 176 is provided on the outer circumferential surface thereof with a hook-shaped holding device (gripper) 177, which can hold the recording medium 124 by gripping the leading end portion of the recording medium 124.

The solvent dryer 178 is disposed in a position facing the outer circumferential surface of the drying drum 176, and includes a plurality of halogen heaters 180, and a plurality of warm-air blow-out nozzles 182, each of which is arranged between adjacent two of the halogen heaters 180.

Each of the warm-air blow-out nozzles 182 is controlled to blow warm air at appropriate temperature at an appropriate blowing rate toward the recording medium 124, and each of the halogen heaters 180 is controlled to appropriate temperature, and it is thereby possible to implement various drying conditions.

The surface temperature of the drying drum 176 is set to 50° C. or above. By heating from the rear side of the recording medium 124, drying is promoted and breaking of the image during fixing can be prevented. There are no particular restrictions on the upper limit of the surface temperature of the drying drum 176, but from the viewpoint of the safety of maintenance operations such as cleaning the ink adhering to the surface of the drying drum 176 (namely, preventing burns due to high temperature), desirably, the surface temperature of the drying drum 176 is not higher than 75° C. (and inure desirably, not higher than 60° C.).

By holding the recording medium 124 in such a manner that the recording surface thereof is facing outward on the outer circumferential surface of the drying drum 176 (in other words, in a state where the recording surface of the recording medium 124 is curved in a convex shape), and drying while conveying the recording medium in rotation, it is possible to prevent the occurrence of wrinkles or floating up of the recording medium 124, and therefore drying non-uniformities caused by these phenomena can be prevented reliably.

The recording medium 124 which has been subjected to the drying treatment in the drying unit 118 is transferred from the drying drum 176 through an intermediate conveyance unit 130 to a fixing drum 184 of the fixing unit 120.

The fixing unit 120 includes the fixing drum 184, a halogen heater 186, a fixing roller 188, and an inline sensor 190. Similar to the treatment liquid drum 154, the fixing drum 184 is provided on the outer circumferential surface thereof with a hook-shaped holding device (gripper) 185, which can hold the recording medium 124 by gripping the leading end portion of the recording medium 124. The recording medium 124 is conveyed by rotation of the fixing drum 184 in a state where the recording surface thereof faces outward, and the preheating by the halogen heater 186, the fixing treatment by the fixing roller 188 and the inspection by the inline sensor 190 are performed with respect to the recording surface.

The halogen heater 186 is controlled to a prescribed temperature (for example, 180° C.), by which the preheating is performed with respect to the recording medium 124.

The fixing roller 188 is a roller member which applies pressure and heat to the dried ink to melt and fix the self-dispersible polymer particles in the ink so as to transform the ink into the film. More specifically, the fixing roller 188 is arranged so as to be pressed against the fixing drum 184, and a nip roller is configured between the fixing roller 188 and the fixing drum 184. As a result, the recording medium 124 is squeezed between the fixing roller 188 and the fixing drum 184, nipped under a prescribed nip pressure (for example, 0.15 MPa), and subjected to fixing treatment.

Further, the fixing roller 188 is configured by a heating roller in which a halogen lamp is incorporated in a metal pipe, for example made from aluminum, having good thermal conductivity and the rollers are controlled to a prescribed temperature (for example 60° C. to 80° C.). Where the recording medium 124 is heated with the heating roller, thermal energy not lower than a Tg temperature (glass transition temperature) of a latex included in the ink is applied and latex particles are melted. As a result, fixing is performed by penetration into the projections-recessions of the recording medium 124, the projections-recessions of the image surface are leveled out, and gloss is obtained.

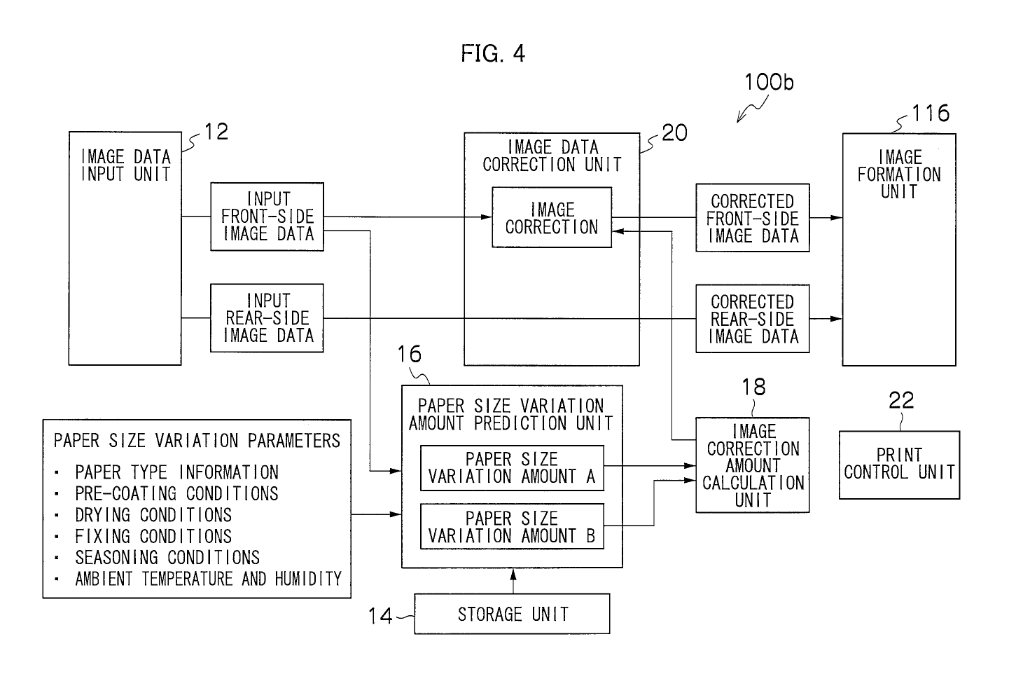

The fixing unit 120 in the embodiment shown in FIG. 4 is provided with the single fixing roller 188; however, it is possible that the fixing roller 188 has a configuration provided with a plurality of steps, dependently on the thickness of image layer and Tg characteristic of latex particles.

On the other hand, the inline sensor 190 is a measuring device which measures the check pattern, moisture amount, surface temperature, gloss, and the like of the image fixed to the recording medium 124. A CCD sensor or the like can be used for the inline sensor 190.

With the fixing unit 120 of the above-described configuration, the latex particles located within a thin image layer formed in the drying unit 118 are melted by application of pressure and heat by the fixing roller 188. Thus, the latex particles can be reliably fixed to the recording medium 124. The surface temperature of the fixing drum 184 is set to 50° C. or above. Drying is promoted by heating the recording medium 124 held on the outer circumferential surface of the fixing drum 184 from the rear side, and therefore breaking of the image during fixing can be prevented, and furthermore, the strength of the image can be increased by the effects of the increased temperature of the image.

If using an ink containing an active light-curable resin, such as a UV-curable resin, instead of the ink containing the thermoplastic resin particles, then the inkjet printing apparatus 100 is thus provided with a device which irradiates the active light, such as a UV lamp or a UV laser diode (LD) array, instead of the fixing roller 188 for heat fixing.

The paper output section 122 is arranged after the fixing unit 120. The paper output section 122 includes the paper output unit 192. A transfer drum 194, a conveyance chain 196, and a tension roller 198 are arranged between the fixing drum 184 of the fixing unit 120 and the paper output unit 192. The recording medium 124 which has passed by the fixing drum 184 is conveyed through the transfer drum 194 to the conveyance chain 196, and is then transferred from the conveyance chain 196 to the paper output unit 192. The composition and operation of the paper output unit 192 are described later.

Although not shown in the drawings, the inkjet printing apparatus 100 in the present embodiment also includes, in addition to the above-described units: an ink storing and loading unit for supplying the inks to the inkjet heads 172M, 172K, 172C and 172Y; a treatment liquid supply unit for supplying the treatment liquid to the treatment liquid deposition unit 114; a head maintenance unit for cleaning the inkjet heads 172M, 172K, 172C and 172Y (e.g., wiping of the nozzle surface, purging, and suction for the nozzles); position determination sensors for determining the position of the recording medium 124 in the medium conveyance path; and temperature sensors for measuring temperature in the respective parts of the inkjet printing apparatus 100.

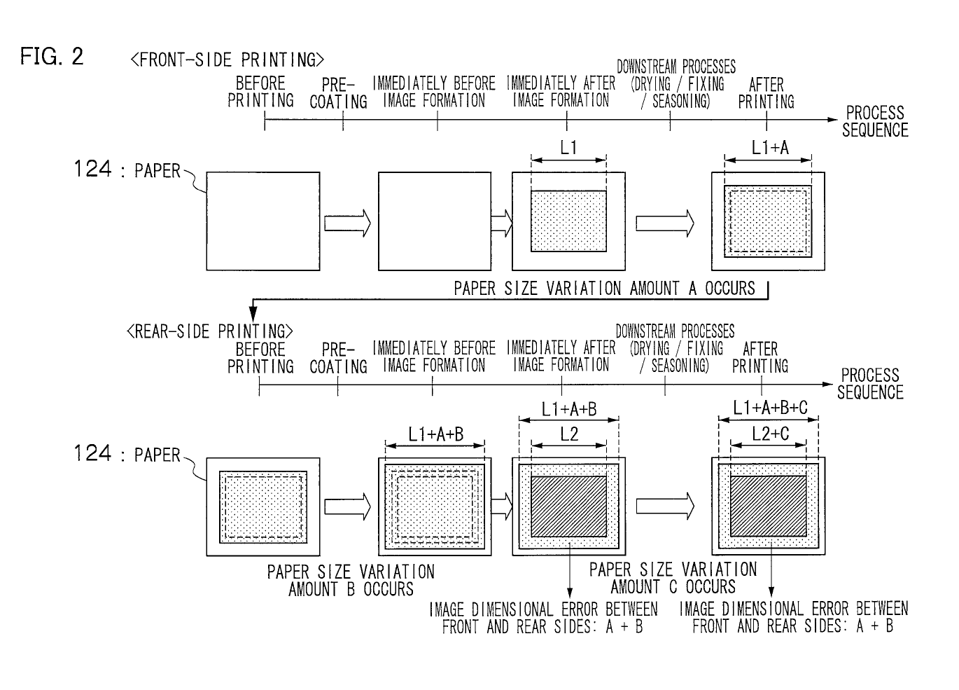

Next, the relationship between the processes and the amounts of size variation occurring in the paper during double-side printing by the inkjet printing apparatus 100 shown in FIG. 1 is described with reference to FIG. 2.

In printing of the front side, the sheet of paper 124 which has been supplied by the paper supply unit 112 is pre-coated (by deposition of the treatment liquid) in a single pass by the treatment liquid deposition unit 114, and an image is then formed (ink is deposited) on the paper 124 in a single pass by the image formation unit 116. Then, the paper 124 is subjected to the drying process performed by the drying unit 118 and the fixing process performed by the fixing unit 120, and is output by the paper output section 122 and then seasoned (by passing air) in the output unit 192.

In the single-pass image formation, it is possible to form an image corresponding to one page by relatively moving the paper 124 and the inkjet heads 172M, 172K, 172C and 172Y once in a single direction. The required image formation time (ink deposition time) in the single-pass method is extremely short (for example, 1.0 second or less in the case of B2 paper), and the paper is held by suction onto the image formation drum 170 (conveyance drum) during the image formation, which means that the amount of size variation occurring in the paper during the image formation is sufficiently small to be regarded as effectively non-existent compared to the amount of size variation occurring in the paper after the image formation. However, a paper size variation amount A that is dependent on the ink volume and the processing conditions in front-side printing, occurs in a period from immediately after the image formation on the front side, through the downstream processes (drying, fixing and seasoning) of the front side, to the start of the deposition of the treatment liquid on the rear side. More specifically, as shown in FIG. 2, dimensional error in the image occurs in accordance with the paper size variation amount A, with respect to the front-side image width L1 immediately after the front-side image formation, and the front-side image width is changed to (L1+A).

The required time for the image formation (ink deposition time) is desirably 1.0 second or less, as described previously, but even if the required time for image formation exceeds 1.0 second, the present invention can still be applied.

When the front-side printing has been completed, the paper 124 in the output unit 192 is returned to the paper supply unit 112 and in rear-side printing, the processes of paper supply, pre-coating, image formation, drying, fixing and seasoning are carried out again. The movement of the paper from the paper output unit 122 to the paper supply unit 112 can be carried out manually or automatically. In order to facilitate understanding of the invention, in the following description, the front-side image width L1 immediately after the front-side image formation and the rear-side image width L2 immediately after the rear-side image formation are taken to be the same (L1=L2).

Since a time lag (of several seconds, for example) occurs from the completion of the pre-coating (treatment liquid deposition) onto the rear side until the start of the rear-side image formation, then a paper size variation amount B that is dependent on the volume of treatment liquid occurs during this time. More specifically, as shown in FIG. 2, dimensional error in the image occurs in accordance with the paper size variation amount of (A+B), with respect to the front-side image width L1 immediately after the front-side image formation, and the front-side image width is changed to (L1+A+B).

Although a paper size variation amount C also occurs in the downstream processes of the rear side (drying, fixing and seasoning), as shown in FIG. 2, the difference between the front-side image width of (L1+A+B+C) and the rear-side image width of (L2+C) is the same amount of (A+B) as immediately after the rear-side image formation.

Hence, it is possible to eliminate relative dimensional error of the images between the front and rear sides by predicting the amount of size variation occurring in the paper during the period from the deposition of ink on the front side to the start of deposition of ink on the rear side, and then correcting the input image data on the basis of this predicted amount of paper size variation.

Below, embodiments of the present invention are described separately in detail.

The first embodiment is described below.

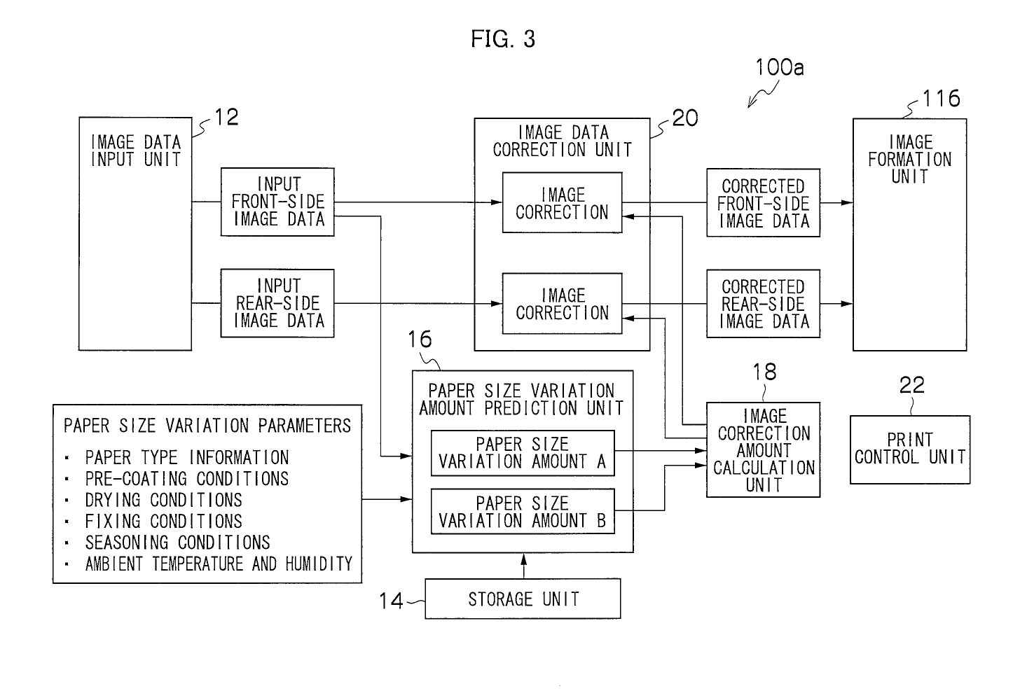

FIG. 3 is a principal block diagram of a control system in the inkjet printing apparatus shown in FIG. 1 according to the first embodiment. As shown in FIG. 3, the inkjet printing apparatus 100a according to the present embodiment includes an image data input unit 12, a storage unit 14, a paper size variation amount prediction unit 16, an image correction amount calculation unit 18, an image data correction unit 20 and a print controller 22.

The image data input unit 12 receives image data that represents an image to be formed on one surface (the front side) of the paper (hereinafter referred to as “input front-side image data”), and image data that represents an image to be formed on the other surface (the rear side) of the paper (hereinafter referred to as “input rear-side image data”). The image data can be input from a removable storage medium, such as a memory card, or can be input through a wired or wireless communication system.

The storage unit 14 is constituted of a memory, for example, and stores a paper size variation amount prediction table, which indicates correspondences between various paper size variation parameters and paper size variation amounts. The paper size variation parameters include, for example, paper type information, pre-coating conditions, drying conditions, fixing conditions, seasoning conditions, and ambient temperature and humidity conditions. The paper type information indicates the type of paper. The pre-coating conditions include the deposition conditions of treatment liquid (referred also to as “pre-coating liquid”) by the treatment liquid deposition unit (114 in FIG. 1). The drying conditions indicate the conditions of drying by the drying unit (118 in FIG. 1). The fixing conditions indicate the conditions of fixing by the fixing unit (120 in FIG. 1). The seasoning conditions indicate the conditions of seasoning in the paper output section (122 in FIG. 1).

The paper size variation amount prediction unit 16, the image correction amount calculation unit 18, the image data correction unit 20 and the print controller 22 are constituted of a CPU (Central Processing Unit), for example. These units can be constituted of dedicated processing circuits.

In the present embodiment, the paper size variation amount prediction unit 16 calculates the following paper size variation amounts A and B: the paper size variation amount A is the amount of size variation occurring in the paper during a period from the end of deposition of ink on the front side to the start of deposition of treatment liquid on the rear side; and the paper size variation amount B is the amount of size variation occurring in the paper during a period from the end of deposition of treatment liquid on the rear side to the start of deposition of ink on the rear side.

The paper size variation amount A is dependent on the ink deposition volume on the front side and the processing conditions for the front-side printing. The paper size variation amount prediction unit 16 calculates the paper size variation amount A on the basis of the input front-side image data, the paper size variation parameters which indicate the processing conditions of front-side printing, and the paper size variation amount prediction table.

The paper size variation amount B is principally dependent on the pre-coating conditions of the rear-side printing. The paper size variation amount prediction unit 16 calculates the paper size variation amount B on the basis of the paper size variation parameters which indicate the pre-coating conditions of the rear-side printing, and the paper size variation amount prediction table.

Thus, the paper size variation amount prediction unit 16 calculates the amount of paper size variation in a period from the end of deposition of ink on the front side to the start of deposition of ink on the rear side, by calculating the paper size variation amounts A and B.

The image correction amount calculation unit 18 calculates an image correction amount for correcting the difference between the actual size of the image formed on the front side of the paper (front-side image) at the start of deposition of ink in the rear-side printing and the image formed on the rear side of the paper (rear-side image) at the start of deposition of ink in the rear-side printing, on the basis of the paper size variation amount predicted by the paper size variation amount prediction unit 16.

The image correction amount calculation unit 18 according to the present embodiment calculates an image correction amount corresponding to the input front-side image data on the basis of the paper size variation amount A, and also calculates an image correction amount corresponding to the input rear-side image on the basis of the paper size variation amount B.

The image data correction unit 20 corrects the input image data on the basis of the image correction amount calculated by the image correction amount calculation unit 18.

The image data correction unit 20 according to the present embodiment corrects both the input front-side image data and the input rear-side image data. In other words, the vertical and horizontal sizes of the front-side image in the input front-side image data are corrected in accordance with the paper size variation amount A, and furthermore the vertical and horizontal sizes of the rear-side image in the input rear-side image data are corrected in accordance with the paper size variation amount B.

The print controller 22 carries out the front-side printing and the rear-side printing (i.e., double-side printing) by controlling the respective sections shown in FIG. 1 (the paper supply unit 112, the treatment liquid deposition unit 114, the image formation unit 116, the drying unit 118, the fixing unit 120, the paper output unit 122, and the like). In this double-side printing, the image formation unit 116 deposits ink onto the paper on the basis of the corrected input image data.

Next, a second embodiment of the present invention is described.

FIG. 4 is a principal block diagram of a control system in the inkjet printing apparatus 100b according to the second embodiment. Below, only the elements which differ from the first embodiment are described.

The image correction amount calculation unit 18 in the present embodiment calculates only an image correction amount corresponding to the input front-side image data, on the basis of the paper size variation amounts A and B. Furthermore, the image data correction unit 20 in the present embodiment corrects only the input front-side image data on the basis of the calculated image correction amount. In other words, the vertical and horizontal sizes of the front-side image in the input front-side image data are corrected in accordance with the paper size variation amounts A and B.

Next, a third embodiment of the present invention is described.

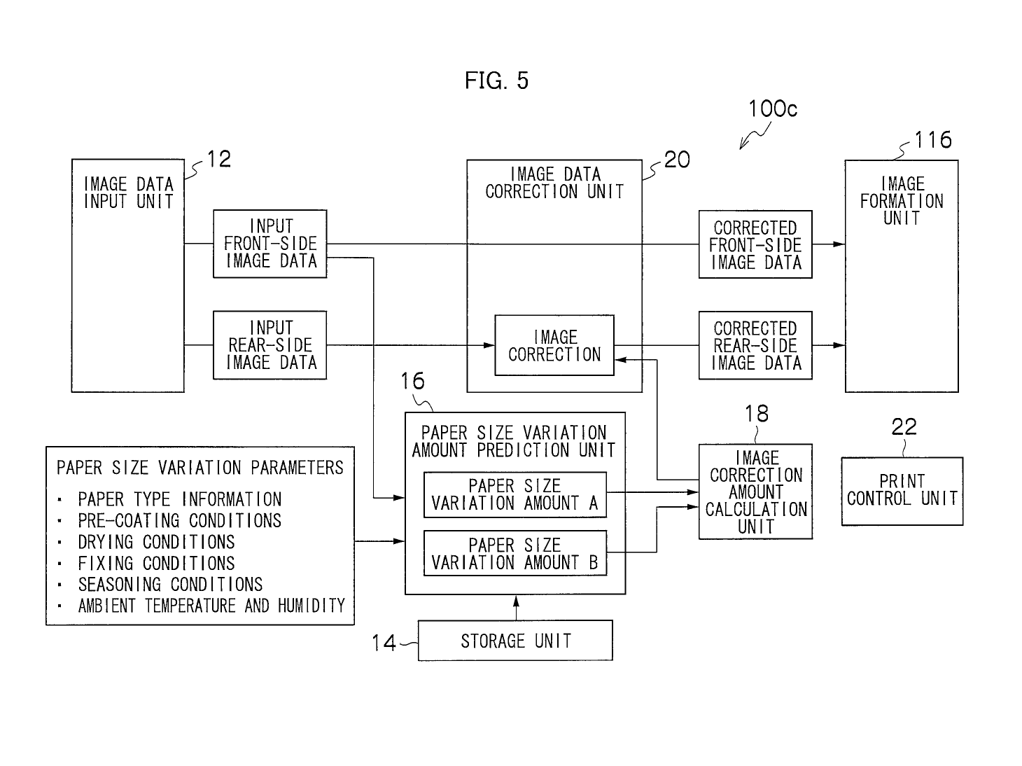

FIG. 5 is a principal block diagram of a control system in the inkjet printing apparatus 100c according to the third embodiment. Below, only the elements which differ from the first embodiment are described.

The image correction amount calculation unit 18 in the present embodiment calculates only an image correction amount corresponding to the input rear-side image data, on the basis of the paper size variation amounts A and B. Furthermore, the image data correction unit 20 in the present embodiment corrects only the input rear-side image data on the basis of the calculated image correction amount. In other words, the vertical and horizontal sizes of the rear-side image in the input rear-side image data are corrected in accordance with the paper size variation amounts A and B.

Next, a fourth embodiment of the present invention is described.

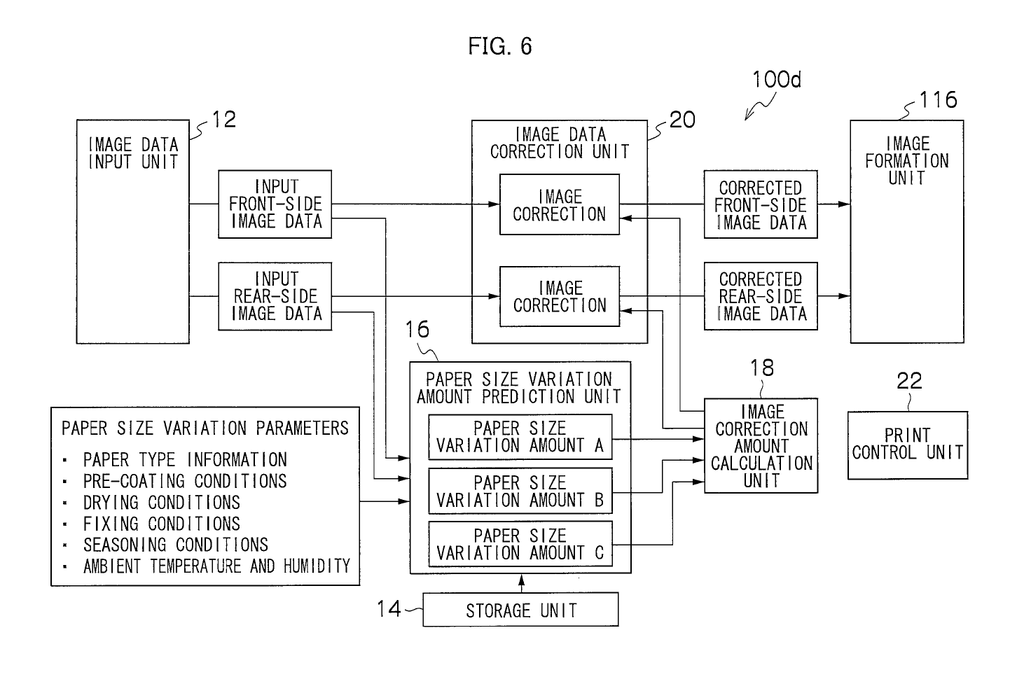

FIG. 6 is a principal block diagram of a control system of the inkjet printing apparatus 100d according to the fourth embodiment. Below, only the elements which differ from the first embodiment are described.

The paper size variation amount prediction unit 16 in the present embodiment predicts the following paper size variation amount C, in addition to the paper size variation amounts A and B: the paper size variation amount C is the amount of size variation occurring in the paper during a period from the end of deposition of ink on the rear side (immediately after image formation) to the completion of the rear-side printing (completion of double-side printing).

The paper size variation amount C is principally dependent on the ink deposition volume on the rear side and the processing conditions of the rear-side printing. The paper size variation amount prediction unit 16 calculates the paper size variation amount C on the basis of the input rear-side image data, the paper size variation parameters which indicate the processing conditions of rear-side printing, and the paper size variation amount prediction table.

The image correction amount calculation unit 18 according to the present embodiment calculates an image correction amount corresponding to the input front-side image data and the input rear-side image data, on the basis of the paper size variation amounts A, B and C. By carrying out image correction on the basis of the paper size variation amount C, as well as the paper size variation amounts A and B, the actual sizes of the front-side image and the rear-side image at the end of the double-side printing are also corrected, in addition to correcting the difference between the actual sizes of the front-side image and the rear-side image on the paper at the time of depositing ink in the rear-side printing. In other words, as well as correcting relative dimensional error of the images between the front and rear sides, absolute dimensional error of the images is also corrected with respect to the paper.

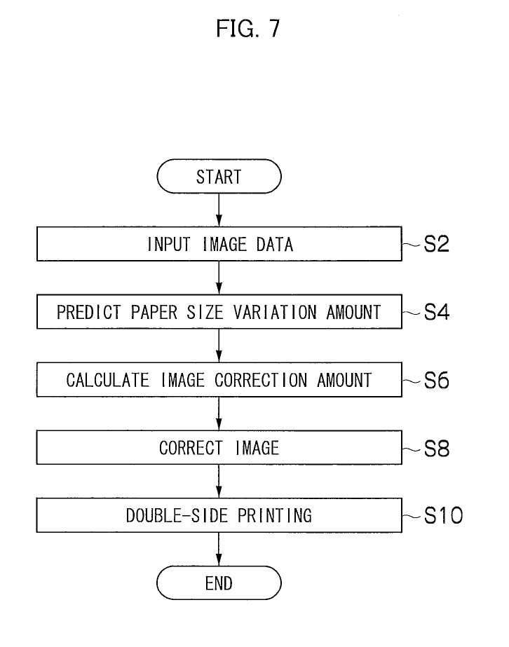

Next, the sequence of an embodiment of a double-side printing process is described with reference to the flowchart in FIG. 7. Below, firstly, a case using the inkjet printing apparatus 100a according to the first embodiment shown in FIG. 3 is described, and then the points of difference with the first embodiment are described in relation to the second to fourth embodiments.

In step S2, input image data (input front-side image data and input rear-side image data) is received by the image data input unit 12.

At step S4, the paper size variation amount prediction unit 16 predicts the paper size variation amounts A and B in a period from the end of ink deposition on the front side (front-side image formation) to the start of deposition of ink on the rear side (rear-side image formation).

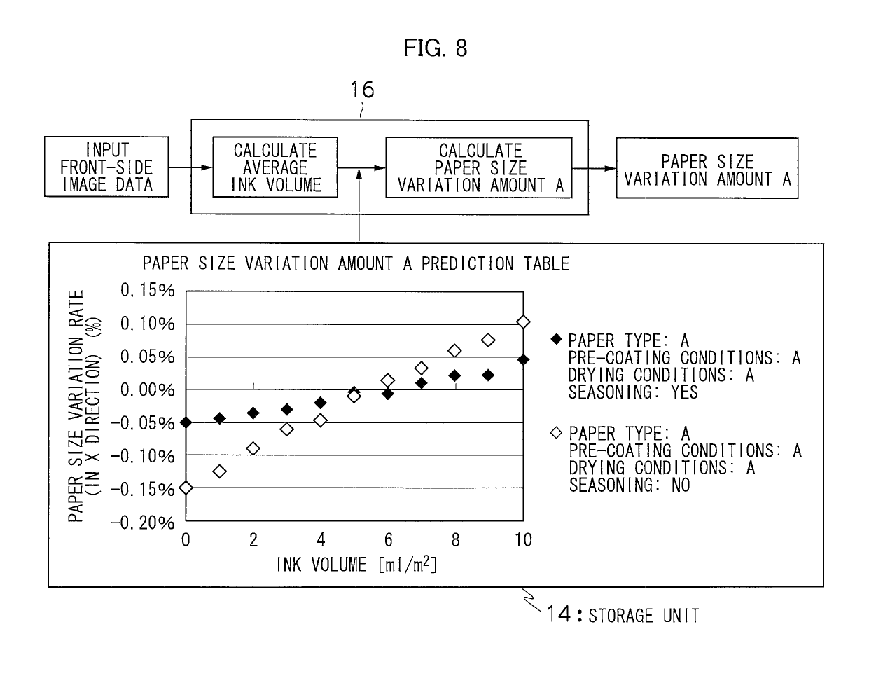

The paper size variation amount A is calculated on the basis of the input front-side image data, the paper size variation parameters which indicate the processing conditions of the front side and the paper size variation amount A prediction table. For example, as shown in FIG. 8, the average ink volume on the front side of the paper is calculated on the basis of the input front-side image data, and the paper size variation amount A is acquired on the basis of this average ink volume, the paper size variation parameters, and the paper size variation amount A prediction table information. Here, the average ink volume means the volume of ink deposited per unit surface area as the image formed on the surface of the paper. The paper size variation amount A differs with the paper type (brand, thickness, texture, etc.), the upstream processing conditions of image formation (pre-coating conditions, etc.), the downstream processing conditions of image formation (drying conditions, seasoning conditions, etc.), and therefore the paper size variation amount A prediction table is prepared respectively for these conditions. The respective conditions in FIG. 8 are as follows:
Paper type A: Oji Paper Group; “OK Top Coat+” having a weight of 127 g/m²;
Pre-Coating Conditions A: Applied amount of 1.7 g/m²;
Drying Conditions A: Pressure drum temperature 60° C., hot air flow temperature 70° C., halogen heater surface temperature 500° C.; and
Seasoning: Blowing of normal-temperature normal-humidity air flow, blowing time: 5 minutes.

To give an example of the paper size variation amount A prediction table, FIG. 8 shows only table information indicating the correspondence between the average ink volume and the paper size variation rate (an example of the amount of paper size variation), in cases where the paper type, pre-coating conditions and drying conditions are the same but the seasoning conditions (in the present embodiment, the presence or absence of seasoning) are different. The paper size variation rate has a positive sign if the paper expands and has a negative sign if the paper contracts. Moreover, in order to simplify the illustration, only the paper size variation rate in the X direction (the direction perpendicular to the paper conveyance direction) is shown; however, it is desirable that paper size variation rates are calculated respectively in the X direction and the Y direction (the paper conveyance direction). As shown in FIG. 8, if seasoning is performed, then the dependence on the ink volume declines. This is because the water content of the paper after image formation is standardized by the seasoning process. In this way, it is desirable that the paper size variation amount prediction unit 16 calculates the paper size variation amount A on the basis of the seasoning conditions of the front side of the paper as well. In the present embodiment, the fixing conditions are ignored, since the effect on the paper size variation rate is small.

Furthermore, a non-uniform size variation corresponding to the image pattern (the distribution of the ink volume) also occurs in addition to the size variation that is uniform throughout the sheet of the paper. Consequently, it is even more desirable that the paper size variation amount prediction unit 16 calculates the paper size variation amount A on the basis of the ink volume distribution on the front side of the paper, by using a function that takes the ink volume and the image position as input parameters, for example.

Furthermore, since the ink deposition volume varies dependently on the print mode, such as high-resolution print mode/high-speed print mode (i.e., low-resolution print mode), and the like, then the paper size variation amount prediction unit 16 may also calculate the paper size variation amount A on the basis of the print mode of the front side of the paper.

The paper size variation amount B is calculated on the basis of the paper size variation parameters which are dependent on pre-coating and a paper size variation amount B prediction table (not shown). The paper size variation amount B prediction table according to the present embodiment indicates the correspondence between the paper type and the pre-coating conditions (treatment liquid deposition volume, the amount of drying of the treatment liquid, and the like), and the paper size variation rate. If the treatment liquid deposition volume (pre-coating liquid volume) and the amount of drying of the treatment liquid (pre-coat drying amount) are altered in accordance with the print mode, then table information corresponding to each print mode is used.

In step S6, the image correction amount calculation unit 18 calculates an image correction amount on the basis of the calculated amounts of paper size variation.

In step S8, the image data correction unit 20 corrects at least one input image data, of the input front-side image data and the input rear-side image data, on the basis of the image correction amount, and thereby corrects the front-side image size with respect to the rear-side image size at the time of ink deposition (image formation) in the rear-side printing. It is possible to use various commonly known algorithms as the image correction processing (enlargement or reduction). For example, an image interpolation algorithm such as nearest neighbor interpolation, bilinear interpolation, bicubic interpolation, or the like, is used.

In step S10, double-side printing is carried out under the control of the print controller 22.

The embodiment of the double-side printing process in the inkjet printing apparatus 100a according to the first embodiment has been described above, and the sequence of the double-side printing process is broadly the same in each of the second to fourth embodiments but the respective steps differ as described below.

In the first to third embodiments, the paper size variation amount prediction (step S4) calculates the paper size variation amounts A and B in order to correct relative dimensional error of the images between the front and rear sides, whereas in the fourth embodiment, this step also calculates the paper size variation amount C in order to correct absolute dimensional error of the images as well.

The amounts of image correction in the image correction amount calculation (step S6) and the image correction (step S8) vary in the first to fourth embodiments, respectively. When the width of the original image before correction in the input front-side image data is taken to be L1, the width of the original image before correction in the input rear-side image data is taken to be L2, then examples of the width L1′ of the image after correction in the input front-side image data and the width L2′ of the image after correction in the input rear-side image data are expressed as follows using the paper size variation amounts A, B and C.

In the first embodiment: L1′=L1−A; and L2′=L2+B.

More specifically, in the first embodiment, the actual size of the image formed on the front side of the paper is corrected by correcting the input front-side image data with the image correction amount of (−A), and the actual size of the image formed on the rear side of the paper is corrected by correcting the input rear-side image data with the image correction amount of (+B). Thereby, the difference in the actual sizes (vertical sizes and horizontal sizes) between the front-side image and the rear-side image of the paper at the time of deposition of ink on the rear side is corrected. In particular, if the original sizes (vertical sizes and horizontal sizes) of the images are the same in the input front-side image data and the input rear-side image data, then the actual size of the front-side image and the actual size of the rear-side image on the paper are matching at the time of ink deposition in the rear-side printing.

In the second embodiment: L1′=L1−A−B; and no correction is made for L2.

More specifically, in the second embodiment, the actual size of the image formed on the front side of the paper is corrected by correcting only the input front-side image data with the image correction amount of (−A−B). In the present embodiment, size correction for one side only is sufficient, and therefore the calculation processing time is reduced.

In the third embodiment: no correction is made for L1; and L2′=L2+A+B.

More specifically, in the third embodiment, the actual size of the image formed on the rear side of the paper is corrected by correcting only the input rear-side image data with the image correction amount of (A+B). In the present embodiment, size correction for one side only is sufficient, and therefore the calculation processing time is reduced.

In the fourth embodiment: L1′=L1−A−B−C; and L2′=L2−C.

More specifically, in the fourth embodiment, the input front-side image data is corrected with the image correction amount of (−A−B−C), and the input rear-side image data is corrected with the image correction amount of (−C). By correcting both the actual size of the front-side image and the actual size of the rear-side image on the paper at the completion of double-side printing, then absolute dimensional errors of the images at the completion of double-side printing are also corrected, in addition to the relative dimensional error of the images between the front and rear sides.

The fourth embodiment has been described with reference to an example where an image correction amount relating to the input front-side image data is calculated on the basis of the paper size variation amounts A, B and C, and furthermore an image correction amount relating to the input rear-side image data is calculated on the basis of the paper size variation amount C; however, the implementation of the fourth embodiment is not limited in particular to this case. It is also possible to calculate an image correction amount corresponding to the input front-side image data on the basis of the paper size variation amounts A and C, and to calculate an image correction amount corresponding to the input rear-side image on the basis of the paper size variation amounts B and C. Furthermore, it is also possible to calculate an image correction amount corresponding to the input front-side image data on the basis of the paper size variation amount C, and to calculate an image correction amount corresponding to the input rear-side image on the basis of the paper size variation amounts A, B and C.

The embodiments of the present invention have been described above with reference to the embodiment of the inkjet printing apparatus 100 shown in FIG. 1, but the present invention is not necessarily limited to these cases.

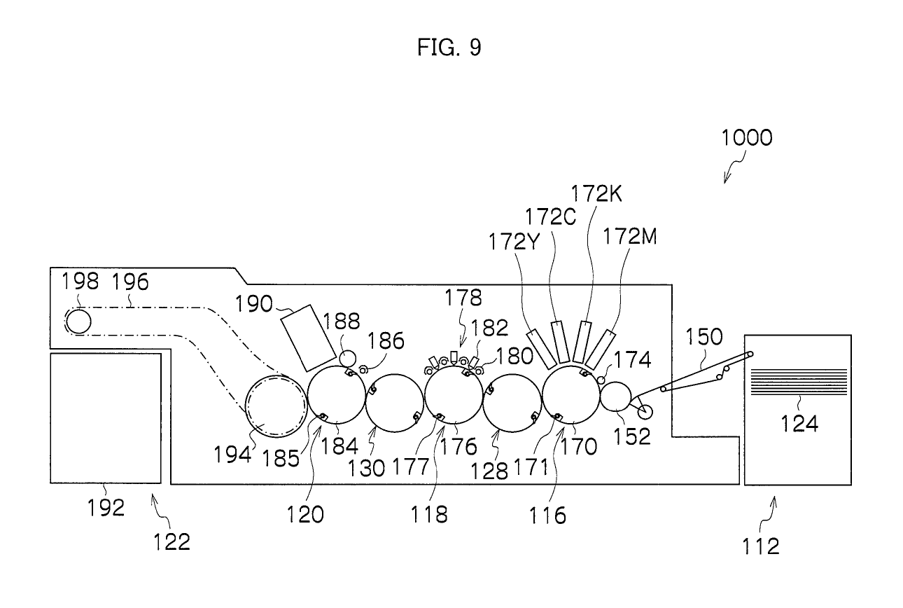

FIG. 9 is a schematic drawing showing an inkjet printing apparatus 1000 according to another embodiment of the present invention. In FIG. 9, the constituent elements shown in FIG. 1 are denoted with the same reference elements, and previously described contents are omitted from the following explanation. In the present embodiment, the treatment liquid deposition unit 114 in FIG. 1 is omitted, and the recording medium (paper) 124 is supplied one sheet at a time to the image formation unit 116 from the paper supply tray 150.

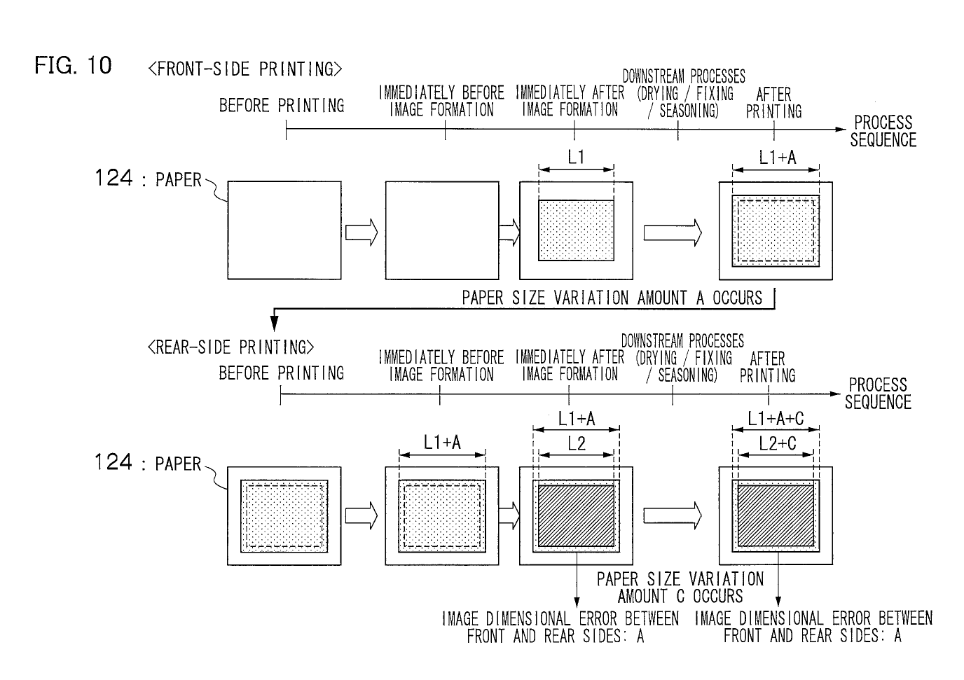

Next, the relationship between the processes and the amounts of size variation occurring in the paper during double-side printing by the inkjet printing apparatus 1000 shown in FIG. 9 is described with reference to FIG. 10.

In printing of the front side, an image is formed (ink is deposited) onto the paper 124 in a single pass by the image formation unit 116. Then, the paper 124 is subjected to the drying process performed by the drying unit 118 and the fixing process performed by the fixing unit 120, and is output by the paper output section 122 and then seasoned (by passing air) in the output unit 192. In printing of the rear side, the processes of image formation, drying, fixing and seasoning are carried out again. In the following explanation, the front-side image width L1 immediately after the front-side image formation and the rear-side image width L2 immediately after the rear-side image formation are taken to be the same (L1=L2).

In the present embodiment, when the front-side image width immediately after the front-side image formation is taken as L1, then the front-side image width immediately before the rear-side image formation is of (L1+A), as shown in FIG. 10. In other words, dimensional error of the image occurs in accordance with the paper size variation amount A. Although a paper size variation amount C also occurs in the downstream processes of the rear side (drying, fixing and seasoning), the difference between the front-side image width of (L1+A+C) and the rear-side image width of (L2+C) is the same A as immediately after the rear-side image formation. Hence, in the present embodiment, it is possible to eliminate relative dimensional error of the images between the front and rear sides by predicting the paper size variation amount A in the period from the end of deposition of ink on the front side to the start of printing on the rear side, and then correcting the input image data on the basis of this predicted paper size variation amount A.

In the following description, the principal parts of the inkjet printing apparatus 1000 in FIG. 9 are described in detail separately for some embodiments.

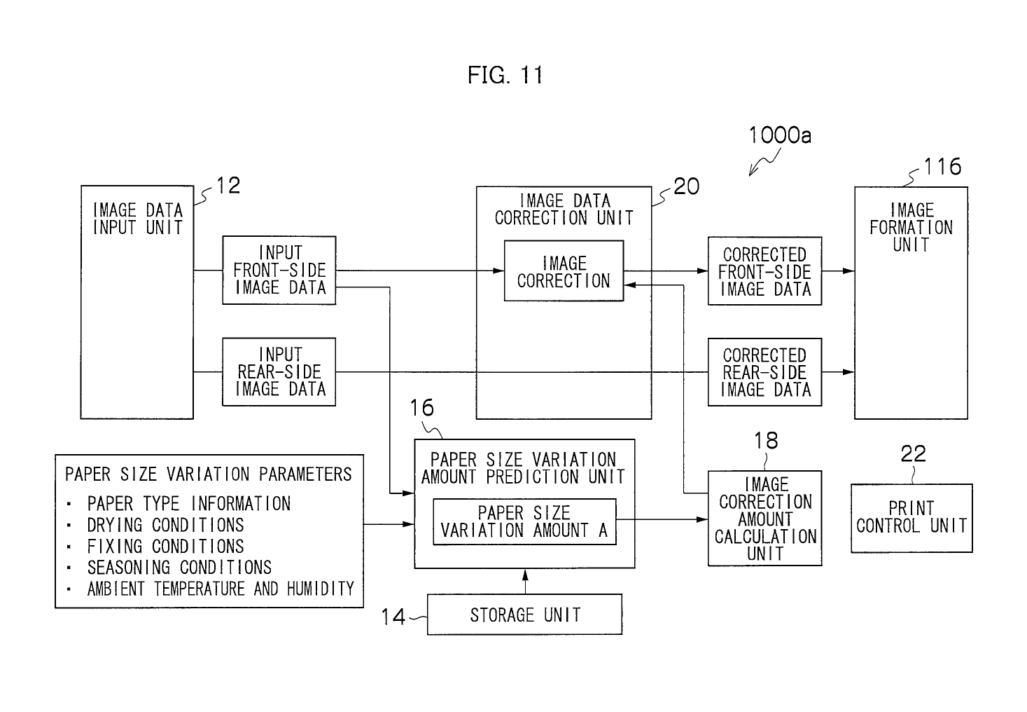

Firstly, the inkjet printing apparatus 1000a according to a fifth embodiment is described with reference to a principal block diagram in FIG. 11. Only those elements which differ from the inkjet printing apparatus 100b according to the second embodiment shown in FIG. 4 are described below.

The image correction amount calculation unit 18 in the fifth embodiment calculates only an image correction amount corresponding to the input front-side image data, on the basis of the paper size variation amount A. In other words, the image data correction unit 20 corrects the vertical and horizontal sizes of the front-side image in the input front-side image data in accordance with the paper size variation amount A.

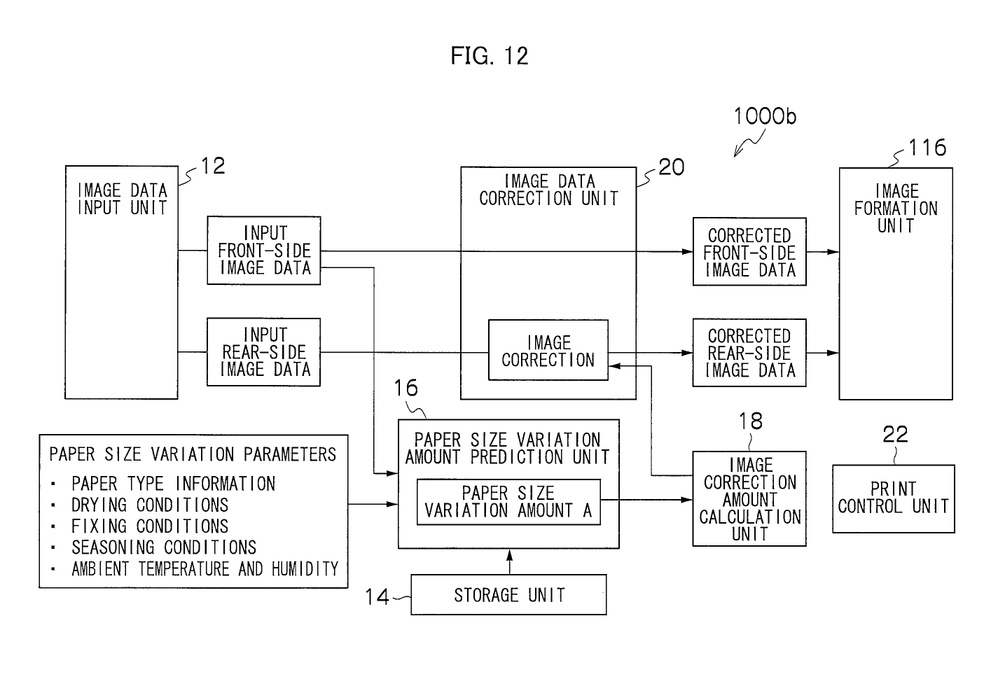

Next, the inkjet printing apparatus 1000b according to a sixth embodiment is described with reference to a principal block diagram in FIG. 12. Only those elements which differ from the inkjet printing apparatus 100c according to the third embodiment shown in FIG. 5 are described below.

The image correction amount calculation unit 18 in the sixth embodiment calculates only an image correction amount corresponding to the input rear-side image data, on the basis of the paper size variation amount A. In other words, the image data correction unit 20 corrects the vertical and horizontal sizes of the rear-side image in the input rear-side image data in accordance with the paper size variation amount A.

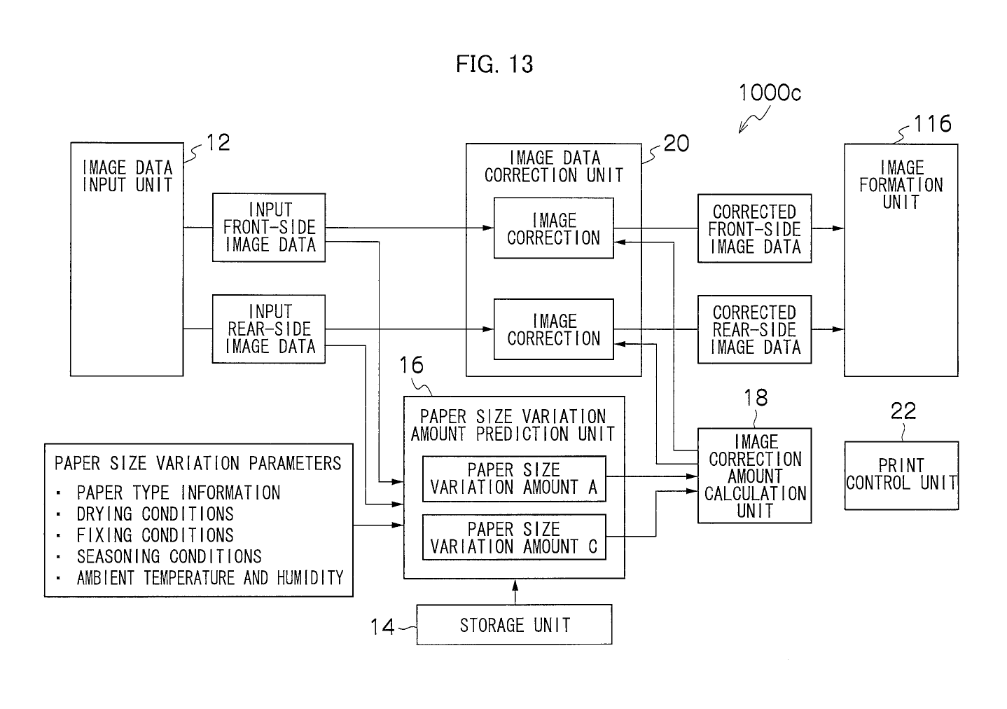

Next, the inkjet printing apparatus 1000c according to a seventh embodiment is described with reference to a principal block diagram in FIG. 13. Only those elements which differ from the inkjet printing apparatus 100d according to the fourth embodiment shown in FIG. 6 are described below.

The image correction amount calculation unit 18 in the seventh embodiment calculates image correction amounts corresponding to the input front-side image data and the input rear-side image data, on the basis of the paper size variation amounts A and C. As described in relation to the fourth embodiment, the paper size variation amount C is the amount of size variation occurring in the paper during a period from the end of ink deposition on the rear side (immediately after image formation) to the completion of the rear-side printing the completion of double-side printing). In other words, similarly to the fourth embodiment, as well as correcting the difference between the actual size of the front-side image and the actual size of the rear-side image on the paper at the time of ink deposition in the rear-side printing, the actual sizes of the front-side image and the rear-side image at the completion of double-side printing are also corrected.

The sequence of the embodiment of a double-side printing process follows the flowchart shown in FIG. 7. However, the amounts of image correction in the image correction amount calculation (step S6) and the image correction (step S8) vary in the fifth to seventh embodiments, respectively. Examples of the width L1′ of the image after correction in the input front-side image data and the width L2′ of the image after correction in the input rear-side image data are expressed as follows, using the paper size variation amounts A and C.

In the fifth embodiment: L1′=L1−A; and no correction is made for L2.

In the sixth embodiment: no correction is made for L1; and L2′=L2+A.

In the seventh embodiment: L1′=L1−A−C; and L2′=L2−C.

The fifth to seventh embodiments have been described with reference to the embodiment of the inkjet printing apparatus 1000 shown in FIG. 9; however, if the paper size variation amount B is sufficiently smaller than the paper size variation amount A so as to be negligible in the inkjet printing apparatus 100 shown in FIG. 1, then it is possible to carry out the paper size variation amount prediction, the image correction amount calculation and the image data correction described in any of the fifth to seventh embodiments. In other words, correction is performed by ignoring the paper size variation amount B shown in FIG. 2.

In the examples described in relation to the first to seventh embodiments, the paper size variation amount A covering all of the downstream processes (for example, drying, fixing and seasoning) after ink deposition is calculated, but the present invention is not limited in particular to this case.

For example, if the amount of paper size variation in one or more of downstream processes of the drying, fixing and seasoning processes after ink deposition is sufficiently small to be negligible, then it is possible to calculate only the amounts of paper size variation for the other downstream processes which are not negligible and to calculate the image correction amounts on the basis of that amount of paper size variation. Furthermore, if one or more of downstream processes of the drying, fixing and seasoning processes after ink deposition is omitted, then the amounts of paper size variation are calculated only in respect of the downstream processes which are carried out. The drying process includes natural drying (drying by the ambient temperature),

Furthermore, the examples have been described in which the calculation start time of the paper size variation amount A is taken as “after the end of ink deposition on the front side”; however, a broader concept of the calculation start time of the paper size variation amount A can be given as “the time of depositing the ink in the front-side printing”. Moreover, the examples have been described where the calculation time of the paper size variation amount B is taken as “after the end of treatment liquid deposition on the rear side”; however, a broader concept of the calculation start time of the paper size variation amount B can be given as “the time of depositing the pre-coating liquid onto the rear side”. Moreover, the examples have been described in which the calculation start time of the paper size variation amount C is taken as “after the end of ink deposition on the rear side”; however, a broader concept of the calculation start time of the paper size variation amount C can be given as “the time of depositing the ink in the rear-side printing”. For example, if the ink deposition duration (or the treatment liquid deposition duration) is short (for example, 1.0 second or less), then the amount of paper size variation during ink deposition (or treatment liquid deposition) is sufficiently small to be negligible, and it is hence sufficient to calculate only the amount of paper size variation from the end of ink deposition (or the end of treatment liquid deposition). On the other hand, if the amount of paper size variation during ink deposition (or treatment liquid deposition) cannot be ignored, then it is preferable that the amount of paper size variation from the start of ink deposition (or the start of treatment liquid deposition) is calculated.

Next, an embodiment of the seasoning mechanism is described in detail.

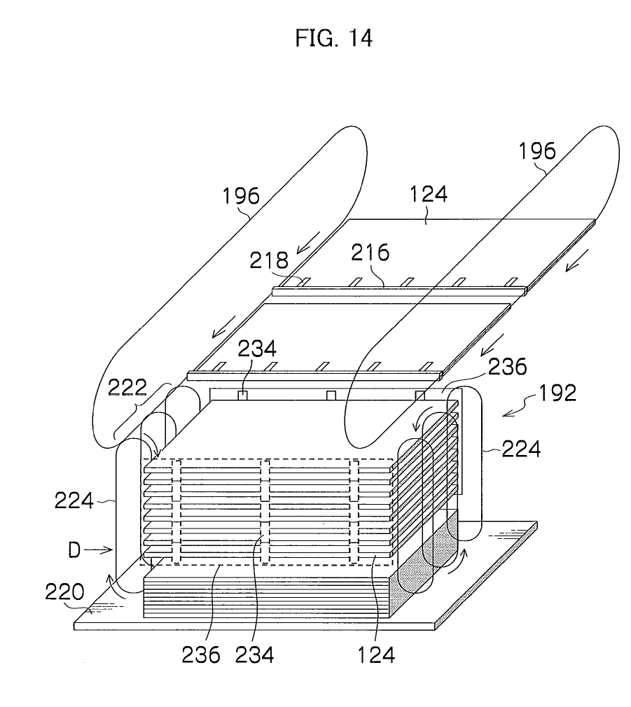

FIG. 14 is a perspective diagram used to describe the paper output unit 192, which includes the seasoning mechanism. In order to aid understanding of the seasoning in the present embodiment, the sheets of paper 124 are depicted with greater than actual thickness.

As shown in FIG. 14, a plurality of bars 216 are arranged on the conveyance chain 196. The bars 216 are spaced apart at intervals which are longer than one edge (here, the shorter edge) of the sheet of paper 124. Each of bars 216 has a plurality of grippers 218 (in FIG. 14, five grippers are shown). The paper 124 after printing is held, one sheet at a time, by the grippers 218 of the bar 216, and is conveyed above the paper output unit 192 by the rotation of the conveyance chain 196. Although the trailing end of the sheet of paper 124 is in an unrestricted (free) state, since the conveyance speed of the conveyance chain 196 is fast, then the sheet of paper 124 is conveyed in a substantially horizontal state.

The paper output unit 192 includes: a paper conveyance mechanism 222, which receives the paper 124 released by the grippers 218 and while holding the paper 124 one sheet at a time separately, conveys the paper to a lower-positioned table 220; and the air blowing device 230 shown in FIG. 15, which blows air flow into the gaps between the sheets of paper 124 from the end face of the paper 124 while the paper is moved by the paper conveyance mechanism 222. The speed of movement of the paper 124 by the paper conveyance mechanism 222 is set to a low speed compared to the speed of movement of the paper 124 by the conveyance chain 196. For example, the conveyance chain 196 conveys the paper 124 to a prescribed transfer position at a speed of one sheet per second, and the grippers 218 release the paper 124 at this transfer position. Air blowing from the air blowing device 230 is carried out during the movement of the paper 124 vertically downward at a slow speed by the paper conveyance mechanism 222, whereby the paper 124 is seasoned so as to approach the ambient temperature and humidity.

The paper conveyance mechanism 222 includes endless traveling bodies 224, and each of the endless traveling bodies 224 is provided with a plurality of hooks having a mechanism capable of holding and releasing the sheet of paper 124. The sheet of paper 124 is held by being gripped between the hooks. The endless traveling bodies 224 grip the sheet of paper 124 which has been released from the grippers 218 of the conveyance chain 196, at a prescribed reception position, and while being held in this state the sheet of paper 124 is moved downward in FIG. 14 due to the movement of the endless traveling bodies 224 and the sheet of paper 124 is then released at a prescribed release position (the position denoted with reference symbol D).

The air blowing device 230 shown in FIG. 15 is arranged on the outer side of the conveyance path of the paper conveyance mechanism 222, and has a plurality of blowers 232 (232a, 232b, 232c, 232a′, 232b′ and 232c′ in FIG. 15) disposed in symmetrical opposing fashion on either side of the conveyance path. Each of the blowers 232 has an air blowing port corresponding to an opening section 234 shown in FIGS. 14 and 15. Side plates 236 are arranged on the outer sides of the paper conveyance path of the paper conveyance mechanism 222 where the blowers 232 are disposed (the sides facing the long ends of the sheets of paper 124), and the opening sections 234 are formed in the side plates 236. The periphery of each opening section 234 is closed off by the wall member (the member of the side plate 236), and the air flow of the blower 232 is introduced through the opening section 234. In this way, the direction of travel of the air flow blown from the blower 232 is restricted, leaking of the air flow is prevented, and the air flow created by the blower 232 can be introduced efficiently into the space of the paper conveyance path, thereby making it possible to supply air efficiently to the gaps between the sheets of paper 124.

The groups of blowers are arranged in a plurality of tiers (for example, five tiers) in the vertical direction, and only the uppermost tier thereof is depicted in the perspective diagram in FIG. 15. The second and lower tiers have a similar composition to the uppermost tier. As shown in FIG. 15, the air blowing device 230 in the present embodiment performs air blowing of a substantially uniform air flow volume, simultaneously, from a first blower row 251 (constituted of the blowers 232a, 232b and 232c) and a second blower row 252 (constituted of the blowers 232a′, 232b′ and 232c′), which are disposed in mutually opposing fashion along the lengthwise direction of the paper 124. Furthermore, by causing the air flow blown from the first blower row 251 and the air flow blown from the second blower row 252 to collide between the sheets of paper 124, turbulence of the air is created forcibly and the air flow is caused to escape from air escape openings 238. By means of this face-to-face air flow and the exiting of air in directions substantially perpendicular to the directions of air blowing (the exiting of air through the air escape openings 238), it is possible to apply the air flow to each of the sheets of paper 124 in approximately uniform fashion, and hence efficient seasoning can be achieved.

The air blowers 232 in the present embodiment have a composition for simply blowing air having the temperature and humidity of the surrounding environment, and have no devices for controlling and adjusting the temperature and humidity, such as a heating device or dehumidifying device. By blowing air of the ambient temperature and humidity between the paper sheets by supplying air from the surrounding environment by means of the blowers 232, the wet portions of the paper sheets are relatively dried, while the dry portions of the paper sheets are relatively moistened, thereby making it possible to equalize the amount of water within the paper sheets (so as to approach the ambient temperature and humidity). Thus, it is possible to cause the paper sheets deformed due to expansion and/or contraction to return to the original state.

According to the paper output unit 192 in the present embodiment described above, before the paper sheets after printing are stacked up on the table 220, it is possible to pass a sufficient air flow between the paper sheets in a state where the individual sheets are separated from each other and gaps are ensured between the sheets. Thus, it is possible to collect the sheets of paper 124 on the table 220 after each of the sheets has been seasoned reliably.

If double-side printing is being performed, then the seasoning is carried out after printing on the front side and before printing on the rear side. After the rear-side printing, it is possible to carry out seasoning similar to that performed after the front-side printing.

Next, the ink is described below.

The ink used in the embodiments of the present invention is aqueous ink containing water as a solvent, and more specifically, for example, an aqueous pigment ink that contains the following materials insoluble to the solvent (water): pigment particles as the coloring material, and the polymer particles.

It is desirable that the concentration of the solvent-insoluble materials in the ink is not less than 1 wt % and not more than 20 wt %, taking account of the fact that the viscosity of the ink suitable for ejection is 20 mPa·s or lower. It is more desirable that the concentration of the pigment in the ink is not less than 4 wt %, in order to obtain good optical density in the image.

It is desirable that the surface tension of the ink is not less than 20 mN/m and not more than 40 mN/m, taking account of ejection stability in the ink ejection head.

The coloring material in the ink may be pigment or a combination of pigment and dye. From the viewpoint of the aggregating characteristics when the ink comes into contact with the treatment liquid, a dispersed pigment in the ink is desirable for more effective aggregation. Desirable pigments include: a pigment dispersed by a dispersant, a self-dispersing pigment, a pigment in which the pigment particle is coated with a resin (hereinafter referred to as “microcapsule pigment”), and a polymer grafted pigment. Moreover, from the viewpoint of the aggregating characteristics of the coloring material, it is more desirable that the coloring material is modified with a carboxyl group having a low degree of disassociation.

It is desirable in the embodiments of the present invention that the colored ink liquid contains polymer particles that do not contain any colorant, as a component for reacting with the treatment liquid. The polymer particles can improve the image quality by strengthening the ink viscosity raising action and the aggregating action through reaction with the treatment liquid. In particular, a highly stable ink can be obtained by adding anionic polymer particles to the ink.

By using the ink containing the polymer particles that produce the viscosity raising action and the aggregating action through reaction with the treatment liquid, it is possible to increase the quality of the image, and at the same time, dependently on the type of polymer particles, the polymer particles may form a film on the recording medium, and therefore beneficial effects can be obtained in improving the wear resistance and the waterproofing characteristics of the image.

The method of dispersing the polymer particles in the ink is not limited to adding an emulsion of the polymer particles to the ink, and the resin may also be dissolved, or included in the form of a colloidal dispersion, in the ink.

The polymer particles may be dispersed by using an emulsifier, or the polymer particles may be dispersed without using any emulsifier. For the emulsifier, a surface active agent of low molecular weight is generally used, and it is also possible to use a surface active agent of high molecular weight. It is also desirable to use a capsule type of polymer particles having an outer shell composed of acrylic acid, methacrylic acid, or the like (core-shell type of polymer particles in which the composition is different between the core portion and the outer shell portion).

Examples of the resin component added as the resin particles to the ink include: an acrylic resin, a vinyl acetate resin, a styrene-butadiene resin, a vinyl chloride resin, an acryl-styrene resin, a butadiene resin, and a styrene resin.

In order to make the polymer particles have high speed aggregation characteristics, it is desirable that the polymer particles contain a carboxylic acid group having a low degree of disassociation. Since the carboxylic acid group is readily affected by change of pH, then the polymer particles containing the carboxylic acid group easily change the state of the dispersion and have high aggregation characteristics.

The change in the dispersion state of the polymer particles caused by change in the pH can be adjusted by means of the component ratio of the polymer particle having a carboxylic acid group, such as ester acrylate, or the like, and it can also be adjusted by means of an anionic surfactant which is used as a dispersant.

Desirably, the resin constituting the polymer particles is a polymer that has both of a hydrophilic part and a hydrophobic part. By incorporating a hydrophobic part, the hydrophobic part is oriented toward to the inner side of the polymer particle, and the hydrophilic part is oriented efficiently toward the outer side, thereby having the effect of further increasing the change in the dispersion state caused by change in the pH of the liquid. Therefore, aggregation can be performed more efficiently.

Moreover, two or more types of polymer particles may be used in combination in the ink.

Examples of the pH adjuster added to the ink in the embodiments of the present invention include an organic base and an inorganic alkali base, as a neutralizing agent. In order to improve storage stability of the ink for inkjet recording, the pH adjuster is desirably added in such a manner that the ink for inkjet recording has the pH of 6 through 10.

It is desirable in the embodiments of the present invention that the ink contains a water-soluble organic solvent, from the viewpoint of preventing nozzle blockages in the ejection head due to drying. Examples of the water-soluble organic solvent include a wetting agent and a penetrating agent.

Examples of the water-soluble organic solvent in the ink are: polyhydric alcohols, polyhydric alcohol derivatives, nitrous solvents, monohydric alcohols, and sulfurous solvents.

Apart from the foregoing, according to requirements, it is also possible that the ink contains a pH buffering agent, an anti-oxidation agent, an antibacterial agent, a viscosity adjusting agent, a conductive agent, an ultraviolet absorbing agent, or the like.

Moreover, it is also possible that the ink contains thermoplastic resin particles. By making the ink contain the thermoplastic resin, film formation progresses during the heating step and the image strength can be improved. If the thermoplastic resin is contained in the ink, it is more beneficial to early out a fixing step of heating and pressing the image, in addition to the heating process during drying.

Furthermore, by making the ink contain the ultraviolet-curable monomer, it possible to improve the strength of the image by irradiating ultraviolet light onto the image in a fixing unit including an ultraviolet irradiation lamp, or the like, after the water has been evaporated off sufficiently in the drying unit, thereby curing and polymerizing the ultraviolet-curable monomer.

Next, the treatment liquid is described below.

It is desirable in the present embodiment that the treatment liquid (aggregating treatment liquid) has effects of generating aggregation of the pigment and the polymer particles contained in the ink by producing a pH change in the ink when coming into contact with the ink.

Specific examples of the contents of the treatment liquid are: polyacrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, pyrrolidone carboxylic acid, pyrone carboxylic acid, pyrrole carboxylic acid, furan carboxylic acid, pyridine carboxylic acid, cumaric acid, thiophene carboxylic acid, nicotinic acid, derivatives of these compounds, and salts of these.

A treatment liquid having added thereto a polyvalent metal salt or a polyallylamine is the preferred examples of the treatment liquid. The aforementioned compounds may be used individually or in combinations of two or more thereof.

From the standpoint of aggregation ability with the ink, the treatment liquid preferably has a pH of 1 to 6, more preferably a pH of 2 to 5, and even more preferably a pH of 3 to 5.

From the standpoint of preventing the nozzles of inkjet heads from being clogged by the dried treatment liquid, it is preferred that the treatment liquid includes an organic solvent capable of dissolving water and other additives. A wetting agent and a penetrating agent are included in the organic solvent capable of dissolving water and other additives.

In order to improve fixing ability and abrasive resistance, the treatment liquid may further include a resin component. Any resin component may be employed, provided that the ejection ability from a head is not degraded when the treatment liquid is ejected by an inkjet system and also provided that the treatment liquid will have high stability in storage. Thus, water-soluble resins and resin emulsions can be freely used.

Apart from the foregoing, according to requirements, it is also possible that the treatment liquid contains a pH buffering agent, an anti-oxidation agent, an antibacterial agent, a viscosity adjusting agent, a conductive agent, an ultraviolet absorbing agent, or the like.

Next, the paper is described below.

There are no particular restrictions on the paper used in the embodiments of the present invention, but particularly desirable effects can be obtained with coated printing paper having slow permeation of the ink solvent.

Possible examples of support media which can be used appropriately for coated paper are: a base paper manufactured using a Fourdrinier paper machine, cylindrical-wire paper machine, twin-wire paper machine, or the like, from main components of pulp and pigment, the pulp being either a chemical pulp such as LBKP or NBKP, a mechanical pulp, such as GP, PGW, RMP, TMP, CTMP, CMP, CGP, or the like, or wood pulp such as recovered paper pulp, such as DIP, and the main components being mixed with one or more additive of a sizing agent, fixing agent, yield enhancer, cationization agent, paper strength enhancer, or the like, or a base paper provided with a size press layer or anchor coating layer formed using starch, polyvinyl alcohol, or the like, or an art paper, coated paper, or cast coated paper, or the like, formed by providing a coating layer on top of the size press layer or anchor coating layer.

It is of course possible to use paper other than the above-described paper.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A printing apparatus, comprising:
an image formation device which performs front-side printing to form a front-side image on a front side of paper by depositing ink in a single pass onto the front side of the paper in accordance with front-side image data, and then performs rear-side printing to form a rear-side image on a rear side of the paper by depositing ink in a single pass onto the rear side of the paper in accordance with rear-side image data;
a paper size variation amount prediction device which predicts an amount of size variation occurring in the paper during a period from a time of depositing the ink in the front-side printing to a time of starting the rear-side printing, in accordance with at least the front-side image data;
an image correction amount calculation device which calculates an image correction amount for correcting a difference between an actual size of the front-side image and an actual size of the rear-side-image on the paper at a time of depositing the ink in the rear-side printing, in accordance with the predicted amount of size variation; and
an image data correction device which corrects at least one of the front-side image data and the rear-side image data to be supplied to the image formation device, in accordance with the calculated image correction amount.

2. The printing apparatus as defined in claim 1, wherein the image data correction device corrects both the front-side image data and the rear-side image data.

3. The printing apparatus as defined in claim 1, wherein the image data correction device corrects only the front-side image data.

4. The printing apparatus as defined in claim 1, wherein the image data correction device corrects only the rear-side image data.

5. The printing apparatus as defined in claim 1, wherein the paper size variation amount prediction device predicts the amount of size variation in accordance with at least an average volume of the ink on the front side of the paper.

6. The printing apparatus as defined in claim 1, wherein the paper size variation amount prediction device predicts the amount of size variation in accordance with at least a volume distribution of the ink on the front side of the paper.

7. The printing apparatus as defined in claim 1, wherein the paper size variation amount prediction device predicts the amount of size variation in accordance with at least a printing mode of the front side of the paper.

8. The printing apparatus as defined in claim 1, further comprising:
a seasoning device which performs seasoning of the paper by blowing air to the paper,
wherein the paper size variation amount prediction device predicts the amount of size variation while taking account of a seasoning condition of the front side of the paper in the seasoning device.

9. The printing apparatus as defined in claim 1, wherein:
the paper size variation amount prediction device further predicts an amount of size variation occurring in the paper during a period from the time of depositing the ink in the rear-side printing to a time of completing the rear-side printing; and
the image data correction device corrects the actual size of the front-side image and the actual size of the rear-side image on the paper at completion of double-side printing by correcting the at least one of the front-side image data and the rear-side image data while taking account of the further predicted amount of size variation.

10. A printing apparatus, comprising:
an image formation device which performs front-side printing to form a front-side image on a front side of paper by depositing ink in a single pass onto the front side of the paper in accordance with front-side image data, and then performs rear-side printing to form a rear-side image on a rear side of the paper by depositing ink in a single pass onto the rear side of the paper in accordance with rear-side image data;
a pre-coating device which deposits a pre-coating liquid onto each of the front side and the rear side of the paper before the ink is deposited;
a paper size variation amount prediction device which predicts a first amount of size variation occurring in the paper during a period from a time of depositing the ink in the front-side printing to a time of starting to deposit the pre-coating liquid onto the rear side of the paper, and predicts a second amount of size variation occurring in the paper during a period from a time of depositing the pre-coating liquid onto the rear side of the paper to a time of starting to deposit the ink onto the rear side of the paper, in accordance with at least a volume of the pre-coating liquid deposited onto the rear side of the paper;
an image correction amount calculation device which calculates an image correction amount for correcting a difference between an actual size of the front-side image and an actual size of the rear-side image on the paper at a time of depositing the ink in the rear-side printing, in accordance with the predicted first and second amounts of size variation; and
an image data correction device which corrects at least one of the front-side image data and the rear-side image data to be supplied to the image formation device, in accordance with the calculated image correction amount.

11. The printing apparatus as defined in claim 10, wherein the paper size variation amount prediction device predicts the first amount of size variation in accordance with at least a volume of the ink on the front side of the paper.

12. The printing apparatus as defined in claim 10, wherein the image data correction device corrects a size of the rear-side image in the rear-side image data in accordance with the predicted second amount of size variation.

13. The printing apparatus as defined in claim 10, wherein the paper size variation amount prediction device predicts the amount of size variation in accordance with at least an average volume of the ink on the front side of the paper.

14. The printing apparatus as defined in claim 10, wherein the paper size variation amount prediction device predicts the amount of size variation in accordance with at least a volume distribution of the ink on the front side of the paper.

15. The printing apparatus as defined in claim 10, wherein the paper size variation amount prediction device predicts the amount of size variation in accordance with at least a printing mode of the front side of the paper.

16. The printing apparatus as defined in claim 10, further comprising:
a seasoning device which performs seasoning of the paper by blowing air to the paper,
wherein the paper size variation amount prediction device predicts the amount of size variation while taking account of a seasoning condition of the front side of the paper in the seasoning device.

17. The printing apparatus as defined in claim 10, wherein:
the paper size variation amount prediction device further predicts an amount of size variation occurring in the paper during a period from the time of depositing the ink in the rear-side printing to a time of completing the rear-side printing; and
the image data correction device corrects the actual size of the front-side image and the actual size of the rear-side image on the paper at completion of double-side printing by correcting the at least one of the front-side image data and the rear-side image data while taking account of the further predicted amount of size variation.

18. A printing control method of carrying out double-side printing using an image formation device which performs front-side printing to form a front-side image on a front side of paper by depositing ink in a single pass onto the front side of the paper in accordance with front-side image data, and then performs rear-side printing to form a rear-side image on a rear side of the paper by depositing ink in a single pass onto the rear side of the paper in accordance with rear-side image data, the method comprising:
a paper size variation amount prediction step of predicting an amount of size variation occurring in the paper during a period from a time of depositing the ink in the front-side printing to a time of starting the rear-side printing, in accordance with at least the front-side image data;
an image correction amount calculation step of calculating an image correction amount for correcting a difference between an actual size of the front-side image and an actual size of the rear-side image on the paper at a time of depositing the ink in the rear-side printing, in accordance with the predicted amount of size variation; and
an image data correction step of correcting at least one of the front-side image data and the rear-side image data to be supplied to the image formation device, in accordance with the calculated image correction amount.

19. A printing control method of carrying out double-side printing using an image formation device which performs front-side printing to form a front-side image on a front side of paper by depositing ink in a single pass onto the front side of the paper in accordance with front-side image data, and then performs rear-side printing to form a rear-side image on a rear side of the paper by depositing ink in a single pass onto the rear side of the paper in accordance with rear-side image data, and a pre-coating device which deposits a pre-coating liquid onto each of the front side and the rear side of the paper before the ink is deposited, the method comprising:
a paper size variation amount prediction step of predicting a first amount of size variation occurring in the paper during a period from a time of depositing the ink in the front-side printing to a time of starting to deposit the pre-coating liquid onto the rear side of the paper, and predicting a second amount of size variation occurring in the paper during a period from a time of depositing the pre-coating liquid onto the rear side of the paper to a time of starting to deposit the ink onto the rear side of the paper, in accordance with at least a volume of the pre-coating liquid deposited onto the rear side of the paper;
an image correction amount calculation step of calculating an image correction amount for correcting a difference between an actual size of the front-side image and an actual size of the rear-side image on the paper at a time of depositing the ink in the rear-side printing, in accordance with the predicted first and second amounts of size variation; and
an image data correction step of correcting at least one of the front-side image data and the rear-side image data to be supplied to the image formation device, in accordance with the calculated image correction amount.
